(19) United States
(12) Patent Application Publication
(10) Pub. No.: US 2014/0035815 A1
(43) Pub. Date: Feb. 6, 2014

(54) 3D POINTING DEVICE

(71) Applicants: Chun-Ming HUANG, Hsinchu City (TW); Gang-Neng SUNG, Hsinchu City (TW); Chien-Ming WU, Hsinchu City (TW)

(72) Inventors: Chun-Ming HUANG, Hsinchu City (TW); Gang-Neng SUNG, Hsinchu City (TW); Chien-Ming WU, Hsinchu City (TW)

(73) Assignee: NATIONAL APPLIED RESEARCH LABORATORIES, Hsinchu City (TW)

(21) Appl. No.: 13/612,190

(22) Filed: Sep. 12, 2012

(30) Foreign Application Priority Data
Aug. 6, 2012 (TW) 101128329

(51) Int. Cl. G06F 3/033

(52) U.S. Cl. 345/158

(57) ABSTRACT

A three-dimensional (3D) pointing device includes a housing, an inertial measurement unit, a data processing unit, a communication unit, and a power unit. The housing has a rough surface, and the inertial measurement unit is provided inside the housing and in contact with the housing. The inertial measurement unit includes a gyroscope and an accelerometer. The data processing unit is used to integrate data from the gyroscope and the accelerometer to generate an output data, so as for the communication unit to send out the output data. The power unit provides power to the 3D pointing device. The 3D pointing device enables the user to execute pointing control in a 3D space and allows the user to input commands by means of the rough surface. Thus, the 3D pointing device features both convenience of use and a small physical volume.

### BACKGROUND OF THE INVENTION

1. Technical Field

The present invention relates to a three-dimensional (3D) pointing device and, in particular, to a 3D pointing device having a rough surface for command input.

2. Description of Related Art

The traditional pointing devices, such as the mice, can only perform pointing control in two-dimensional (2D) directions. In order to perform pointing control during keyboard typing, one must move one hand to a mouse for such control and move the hand back to the keyboard to continue typing. The hand movements in the process are quite large. If pointing control can be directly executed in a 3D space, not only can hand movements be significantly reduced, but also the need for an ergonomic design can be met

US Patent Application Publication No. 2003/0142065 discloses a ring with inertial sensors, such as accelerometers and rate gyros, for detecting finger movements. The ring is also provided with buttons for inputting user commands to a computer. Thus, one who is typing on a keyboard can perform pointing control with subtle hand movements and use the buttons to input control commands at the same time.

The buttons of the abovementioned device—though configured specifically for the input of control commands—are nevertheless bulky and require a complicated internal circuitry. Hence, there is a need for an improved device having a simpler circuit design and a smaller volume.

### SUMMARY OF THE INVENTION

The present invention relates to a 3D pointing device which includes a housing, an inertial measurement unit, a data processing unit, a communication unit, and a power unit. The present invention enables the user to perform pointing control in a 3D space and allows the user to input commands via a rough surface. Thus, the 3D pointing device is both convenient to use and compact in size.

The present invention provides a three-dimensional (3D) pointing device, comprising: a housing having a rough surface; an inertial measurement unit provided in the housing and in contact with the housing, the inertial measurement unit comprising: a gyroscope for detecting an angular acceleration of the housing and outputting rotation data; and an accelerometer for detecting a linear acceleration of the housing and outputting acceleration data, and for detecting a specific frequency generated from the rough surface and outputting frequency data; a data processing unit for integrating the rotation data, the acceleration data, and the frequency data to generate output data; a communication unit for transmitting the output data; and a power unit for providing power to the 3D pointing device.

Implementation of the present invention at least provides the following advantageous effects:

1. Pointing control can be executed in a 3D space;

2. The convenience of use and the variety of uses of the disclosed device are increased as compared with the prior art; and

3. The volume of the disclosed device is reduced as compared with the prior art.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

FIG. 1 is a perspective view of the 3D pointing device in an embodiment of the present invention;

FIG. 2 is a block diagram of the 3D pointing device depicted in FIG. 1;

FIG. 3A shows the first aspect of the single set of rough lines in an embodiment of the present invention;

FIG. 3B shows the second aspect of the single set of rough lines depicted in FIG. 3A;

FIG. 4A shows the first aspect of the multiple sets of rough lines in an embodiment of the present invention;

FIG. 4B shows the second aspect of the multiple sets of rough lines depicted in FIG. 4A;

FIG. 4C shows the third aspect of the multiple sets of rough lines depicted in FIG. 4A;

FIG. 4D shows the fourth aspect of the multiple sets of rough lines depicted in FIG. 4A;

FIG. 4E shows the fifth aspect of the multiple sets of rough lines depicted in FIG. 4A;

FIG. 5 is a plot showing the signals of an accelerometer in an embodiment of the present invention; and

FIG. 6 is another plot showing the signals of the accelerometer in the embodiment of FIG. 5.

### DETAILED DESCRIPTION OF THE EMBODIMENTS OF THE INVENTION

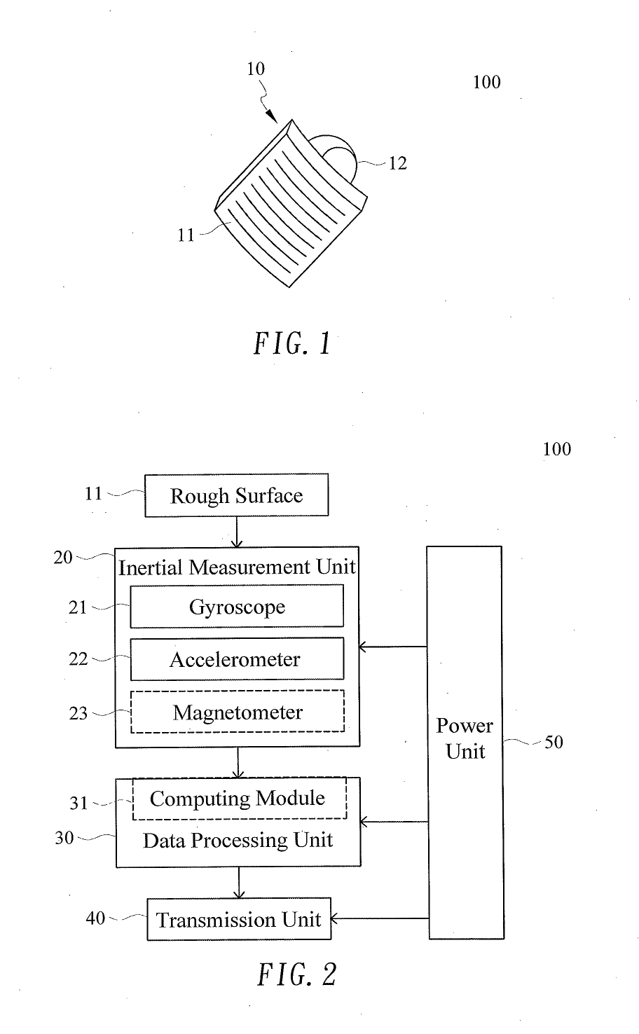

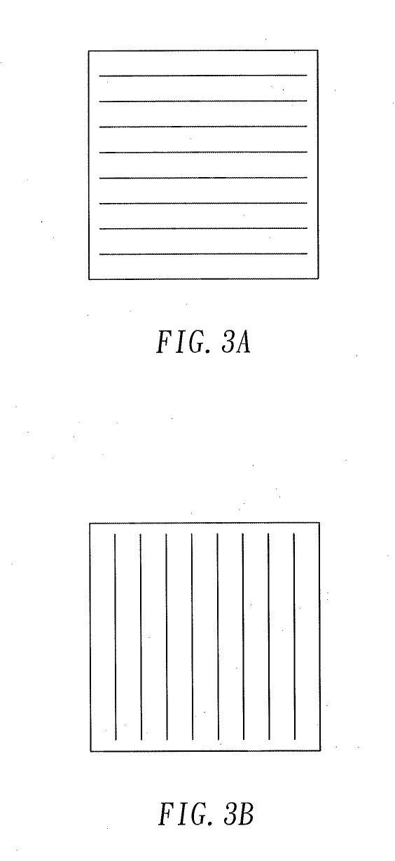

Referring to FIG. 1 and FIG. 2, a 3D pointing device 100 according to an embodiment of the present invention includes a housing 10, an inertial measurement unit 20, a data processing unit 30, a communication unit 40, and a power unit 50.

The housing 10, provided as the main body of the 3D pointing device 100, is used for protecting the internal components arranged therein. If the 3D pointing device 100 is designed to be worn on a finger, the housing 10 can be provided with a ring 12. The ring 12 is attached to the bottom surface of the housing 10 and is penetrable by a finger such that the ring 12 is retained thereon. Furthermore, the housing 10 has a rough surface 11. The rough surface 11 can be of various configurations, provided that the rough surface 11 can generate vibrations of a specific frequency and transfer the vibrations to the housing 10 when a finger slides over the rough surface 11.

Referring now to FIG. 3a and FIG. 3b, the rough surface 11 can be formed with a set of rough lines extending in one direction. As the spacing between this set of rough lines varies, the rough surface 11 can generate vibrations of different frequencies when the user's finger slides over the rough surface 11. The spacing of the rough lines may be adjusted according to the desired vibration frequency. The direction of the rough lines may also be designed to enhance convenience of use. For example, the rough lines may be arranged horizontally, vertically, with a leftward slant, or with a rightward slant. Each rough line can be formed by a plurality of particles, and the particles are arranged at a uniform density.

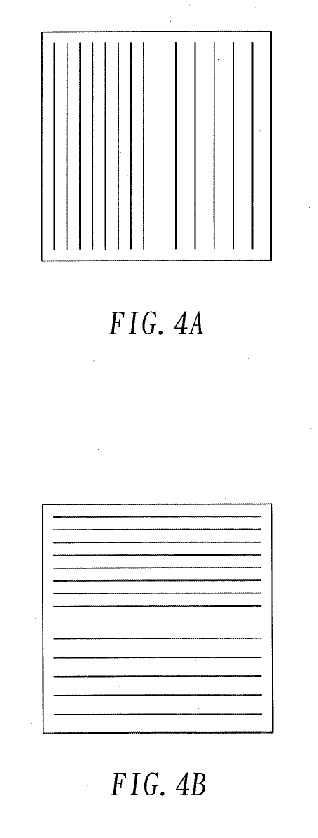

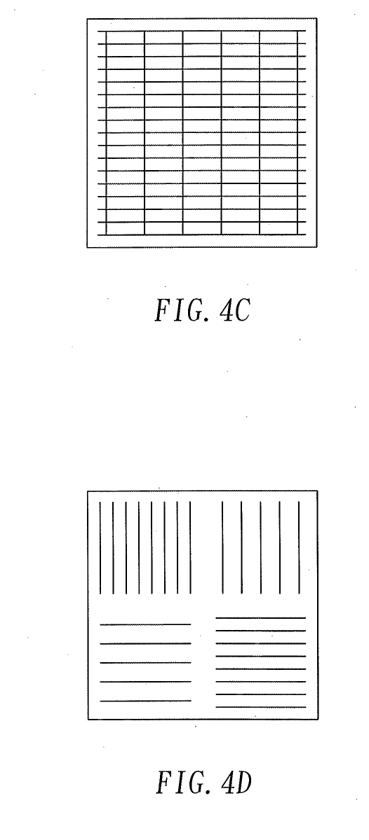

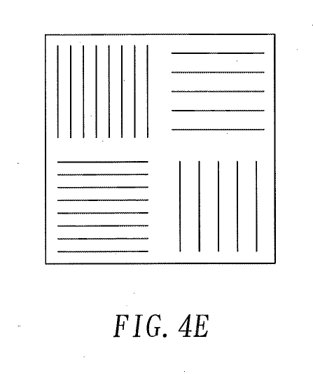

Referring now to FIG. 4a to FIG. 4e, the rough surface 11 can be formed with multiple sets of rough lines, wherein the multiple sets of rough lines extend in at least one direction and have different densities. With the multiple sets of rough lines, the rough surface 11 can generate vibrations of different specific frequencies when a finger slides over these different sets of rough lines, allowing the user to input different control commands. Therefore, the rough lines may be arranged in many different ways. The direction or directions of the rough lines may be designed to enhance convenience of use. For example, the rough lines may be arranged horizontally, vertically, with a leftward slant, or with a rightward slant. Each rough line can be formed by a plurality of particles, and the particles are arranged at a uniform density.

As shown in FIG. 4a, the first aspect of the arrangement of the multiple sets of rough lines includes two sets of rough lines, wherein the two sets are horizontally arranged and have different densities. As the vibration frequency generated when a finger slides over the first set of rough lines is different from that generated when the finger slides over the second set of rough lines, the different vibration frequencies can be defined as different control commands and be used in place of the control commands defined by, for example, a single click or a double click on a mouse.

Referring to FIG. 4b, the second aspect of the arrangement of the multiple sets of rough lines includes two sets of rough lines, wherein the two sets are vertically arranged and have different densities.

Referring to FIG. 4c, the third aspect of the arrangement of the multiple sets of rough lines includes a set of horizontally arranged rough lines and a set of vertically arranged rough lines whose density is different from that of the horizontally arranged rough lines.

Referring to FIG. 4d and FIG. 4e, the fourth and fifth aspects of the arrangement of the multiple sets of rough lines each include two sets of rough lines of different densities in each of the vertical and horizontal directions such that four different specific frequencies can be generated. It is understood that FIG. 4a to FIG. 4e are provided only to show five possible embodiments and the present invention shall not be limited to these five embodiments.

As shown in FIG. 2, the inertial measurement unit 20 is provided in the housing 10 and is in contact with the housing 10. Thus, the vibrations transferred from the rough surface 11 to the housing 10 can be further transferred to the inertial measurement unit 20. The inertial measurement unit 20 includes gyroscopes 21 and accelerometers 22 and may further include a magnetometer 23.

When the 3D pointing device 100 is used for pointing control in a 3D space, the gyroscope 21 can generate electric signals according to the angular movement of the housing 10 in the 3D space, thereby detecting in real time the angular acceleration of the housing 10 during its movement. Then, the gyroscope 21 outputs the rotation data thus obtained.

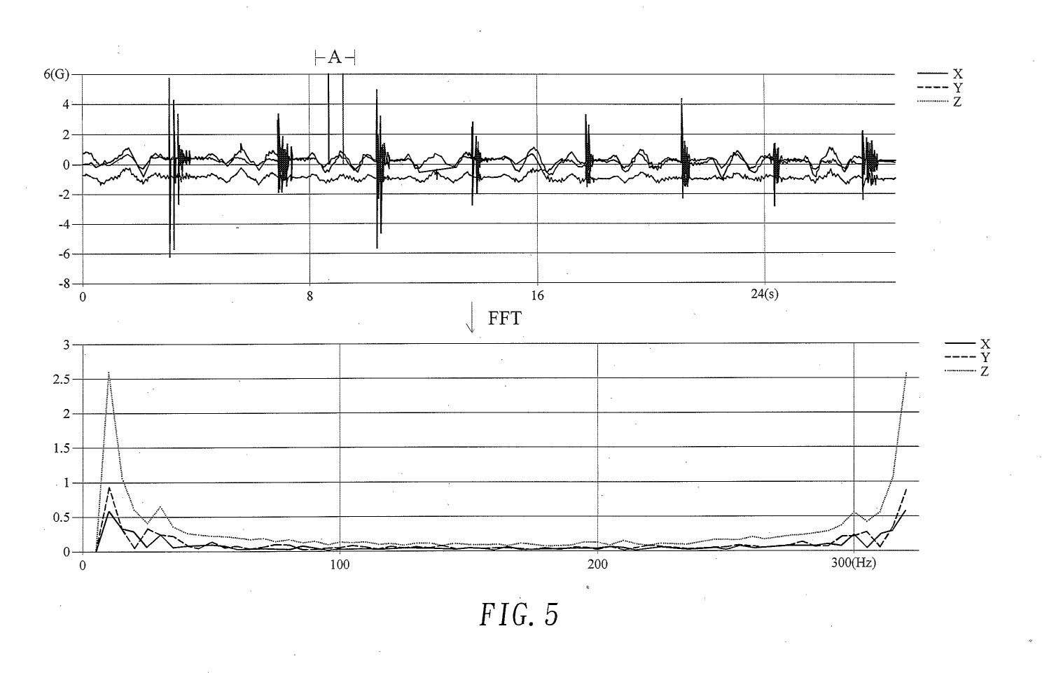

When the 3D pointing device 100 is used for pointing control in a 3D space, any change in the speed of movement of the housing 10 in the 3D space will cause the mass in the accelerometer 22 to move; as a result, a change of electric signals takes place. The accelerometer 22 can thus detect in real time the linear acceleration of the housing 10 during its movement and then output the acceleration data obtained. For example, the accelerometers 22 of three directions (x, y, z) can separately obtain the time-amplitude data in the corresponding direction (x, y, z). Referring to FIG. 5, zone A of the upper graph is the time-amplitude data of the 3D pointing device 100 when performing pointing control in a 3D space. By Fast Fourier Transform (FFT), zone A is transformed into the lower graph, which includes frequency-amplitude data for further analysis and output as the acceleration data. Once the rotation data and acceleration data are known, the way the 3D pointing device 100 moves in the 3D space can be derived to enable pointing control.

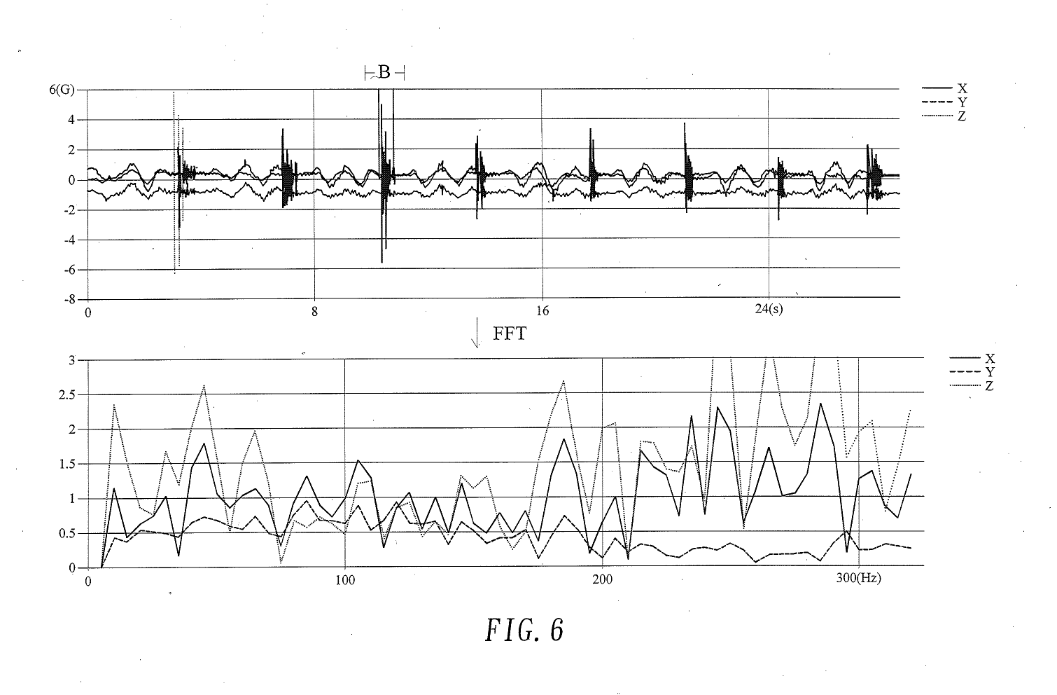

Due to its wide frequency response, the accelerometer 22 can also detect the vibrations generated from the rough surface 11 when a finger slides over the rough surface 11. Referring to FIG. 6, zone B of the upper graph is the time-amplitude data corresponding to the specific vibration frequency generated by rubbing the rough surface 11 when the 3D pointing device 100 is used for pointing control in a 3D space. By Fast Fourier Transform (FFT), zone B is transformed into the frequency-amplitude data shown in the lower graph. The frequency-amplitude data are then analyzed and output as frequency data.

The magnetometer 23 detects the direction of the geomagnetic field based on the change of electric signals caused by the geomagnetic field and outputs the geomagnetic data thus obtained, which further provides direction data of the 3D pointing device 100.

The data processing unit 30 integrates the rotation data generated by the gyroscope 21 with the acceleration data and the frequency data generated by the accelerometer 22 to produce output data. If the 3D pointing device 100 includes the magnetometer 23, the data processing unit 30 will further integrate into the output data the geomagnetic data generated by the magnetometer 23. In addition, an input end of the data processing unit 30 may include a computing module 31. When the rotation data, acceleration data, and frequency data are needed for different applications, the computing module 31 can read and compute the rotation data, acceleration data, and frequency data. Similarly, if the 3D pointing device 100 includes the magnetometer 23, the computing module 31 can be used for reading and computing the geomagnetic data.

The communication unit 40 is a device for transmitting the output data integrated by the data processing unit 30 to a device which is controlled by the 3D pointing device 100 in order to perform pointing control. The device can be a computer, a television, or a CD/DVD player. The transmission unit 40 can be a wired communication unit or a wireless communication unit. The wired communication unit can be a 4/8-bit MCU or USB MCU communication unit, whereas the wireless communication unit can be a Wi-Fi, Bluetooth, Zigbee, or 433-MHz RF communication unit.

The power unit 50 is used to provide power to the 3D pointing device 100. The power unit 50 can be a primary battery, a secondary battery, a solar battery, a piezoelectric component, a thermoelectric component, or a combination thereof.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A three-dimensional (3D) pointing device, comprising:
a housing having a rough surface;
an inertial measurement unit provided in the housing and in contact with the housing, the inertial measurement unit comprising:
a gyroscope for detecting an angular acceleration of the housing and outputting rotation data; and
an accelerometer for detecting a linear acceleration of the housing and outputting acceleration data, and for detecting a specific frequency generated from the rough surface and outputting frequency data;
a data processing unit for integrating the rotation data, the acceleration data, and the frequency data to produce output data;
a communication unit for transmitting the output data; and
a power unit for providing power to the 3D pointing device.

2. The 3D pointing device of claim 1, further comprising a ring attached to a bottom surface of the housing.

3. The 3D pointing device of claim 1, wherein the rough surface is formed with a set of rough lines extending in one direction.

4. The 3D pointing device of claim 3, wherein said direction is a horizontal direction, a vertical direction, a left-slanting direction, or a right-slanting direction.

5. The 3D pointing device of claim 3, wherein each said rough line is formed by a plurality of particles arranged at a uniform density.

6. The 3D pointing device of claim 1, wherein the rough surface is formed with multiple sets of rough lines, and the multiple sets of rough lines extend in at least one direction and have different densities.

7. The 3D pointing device of claim 6, wherein said direction is a horizontal direction, a vertical direction, a left-slanting direction, or a right-slanting direction.

8. The 3D pointing device of claim 6, wherein each said rough line is formed by a plurality of particles, and the particles are arranged at a uniform density.

9. The 3D pointing device of claim 1, wherein the inertial measurement unit further comprises a magnetometer for detecting a geomagnetic field direction and outputting geomagnetic data, and the data processing unit further integrates the geomagnetic data into the output data.

10. The 3D pointing device of claim 1, wherein the data processing unit has an input end provided with a computing module for reading and computing the rotation data, the acceleration data, and the frequency data.

11. The 3D pointing device of claim 1, wherein the communication unit is a wired communication unit or a wireless communication unit.

12. The 3D pointing device of claim 1, wherein the power unit is a primary battery, a secondary battery, a solar battery, a piezoelectric component, a thermoelectric component, or a combination thereof.
